(19) United States
(12) Patent Application Publication
(10) Pub. No.: US 2026/0054422 A1
(43) Pub. Date: Feb. 26, 2026

(54) REUSE METHOD OF USED PET FILM, PELLET, AND RESIN MOLDED ARTICLE

(71) Applicant: KYOCERA Document Solutions Inc., Osaka (JP)

(72) Inventors: Koichiro TSUJIMOTO, Osaka (JP); Rina UENISHI, Osaka (JP); Teruo MORI, Osaka (JP); Tomochika OKUYAMA, Osaka (JP); Yosuke OKUNO, Osaka (JP)

(73) Assignee: KYOCERA Document Solutions Inc., Osaka (JP)

(21) Appl. No.: 19/306,956

(22) Filed: Aug. 21, 2025

(30) Foreign Application Priority Data
Aug. 23, 2024 (JP) 2024-143428

(51) Int. Cl. B29B 17/04; B29B 17/02; B29C 49/00; B29C 49/06; B29K 67/00; B29K 83/00; B29L 31/00; B29L 31/34

(52) U.S. Cl. CPC B29B 17/0412; B29B 17/02; B29C 49/0005; B29C 49/06; B29B 2017/0217; B29K 2067/003; B29K 2083/00; B29L 2031/3406; B29L 2031/7678

(57) ABSTRACT

A reuse method of a used PET film, with a ceramic stuck to a surface thereof, is provided. The reuse method of the used PET film includes a repelletizing process, a pellet mixing process, and a molding process. The repelletizing process includes producing a first pellet by repelletizing the used PET film. The pellet mixing process includes mixing the first pellet produced through the repelletizing process, with a second pellet containing a lower percentage of components other than PET than the first pellet. The molding process includes forming a resin molded article through an injection blow molding process, from the first pellet and the second pellet, mixed together in the pellet mixing process.

### INCORPORATION BY REFERENCE

This application claims priority to Japanese Patent Application No.2024-143428 filed on Aug. 23, 2024, the entire contents of which are incorporated by reference herein.

### BACKGROUND

The present disclosure relates to a reuse method of a used PET film, a pellet, and a resin molded article, and in particular to the reuse method of the used PET film with the ceramic stuck to the surface thereof, the pellet, and the resin molded article.

As part of environmental resources management, reuse of materials has come to be promoted. For example, a PET film is used as a carrier film in an intermediate process in the manufacturing of layered electronic parts, such as a multilayer ceramic capacitor, and the reuse of the used PET film is also being promoted. Examples of a reuse method of the used PET film include removing a deposited substance from the surface of the used PET film, repelletizing the used PET film from which the deposited substance has been removed, thereby producing pellets, and reproducing the PET film using the pellets.

### SUMMARY

The disclosure proposes further improvement of the foregoing technique.

In an aspect, the disclosure provides a reuse method of a used PET film, with a ceramic stuck to a surface thereof. The reuse method of the used PET film includes a repelletizing process, a pellet mixing process, and a molding process. The repelletizing process includes producing a first pellet by repelletizing the used PET film. The pellet mixing process includes mixing the first pellet produced through the repelletizing process, with a second pellet containing a lower percentage of components other than PET than the first pellet. The molding process includes forming a resin molded article through an injection blow molding process, from the first pellet and the second pellet, mixed together in the pellet mixing process.

In another aspect, the disclosure provides a pellet to be produced from a used PET film with a ceramic stuck to a surface thereof. The pellet is produced by repelletizing the used PET film.

In still another aspect, the disclosure provides a resin molded article formed from a used PET film with a ceramic stuck to a surface thereof. A first pellet is produced by repelletizing the used PET film. The first pellet is mixed with a second pellet containing a lower percentage of components other than PET than the first pellet. The resin molded article is formed through an injection blow molding process, from the first pellet and the second pellet mixed together.

### BRIEF DESCRIPTION OF THE DRAWINGS

FIG. 1A is a perspective view showing a stage of a manufacturing process of a multilayer ceramic capacitor, for explaining how a ceramic is stuck to the surface of a PET film, to be used for the reuse method of the used PET film according to a first embodiment of the disclosure;

FIG. 1B is a perspective view showing another stage of the manufacturing process of the multilayer ceramic capacitor;

FIG. 1C is a perspective view showing another stage of the manufacturing process of the multilayer ceramic capacitor;

FIG. 1D is a perspective view showing another stage of the manufacturing process of the multilayer ceramic capacitor;

FIG. 2 is a flowchart showing steps of the reuse method of the used PET film according to the first embodiment;

FIG. 3A is a schematic perspective view showing an article involved in the reuse method of the used PET film specified in FIG. 2;

FIG. 3B is a schematic drawing showing articles involved in the reuse method of the used PET film specified in FIG. 2;

FIG. 3C is a schematic drawing showing other articles involved in the reuse method of the used PET film specified in FIG. 2;

FIG. 3D is a schematic perspective view showing another article involved in the reuse method of the used PET film specified in FIG. 2;

FIG. 4 is a flowchart showing steps of the reuse method of the used PET film according to a second embodiment of the disclosure;

FIG. 5A is a schematic perspective view showing an article involved in the reuse method of the used PET film specified in FIG. 4;

FIG. 5B is a schematic perspective view showing another article involved in the reuse method of the used PET film specified in FIG. 4;

FIG. 5C is a schematic drawing showing articles involved in the reuse method of the used PET film specified in FIG. 4;

FIG. 5D is a schematic drawing showing other articles involved in the reuse method of the used PET film specified in FIG. 4;

FIG. 5E is a schematic perspective view showing another article involved in the reuse method of the used PET film specified in FIG. 4; and FIG. 6 is a schematic drawing for explaining a mechanism for removing the ceramic stuck to the surface of the used PET film, in the ceramic removal process included in FIG. 4.

### DETAILED DESCRIPTION

Hereafter, a reuse method of a used PET film, according to some embodiments of the disclosure, will be described with reference to the drawings.

### First Embodiment

The reuse method of the used PET film according to a first embodiment of the disclosure will be described hereunder, with reference to the drawings.

To start with, a used PET film with a ceramic stuck to the surface thereof will be described.

The PET film is used, for example, in an intermediate process of manufacturing of layered electronic parts, such as a multilayer ceramic capacitor. When the PET film is used in the intermediate process of the manufacturing of the layered electronic parts, a ceramic is stuck to the surface of the PET film. The used PET film, having the residual ceramic stuck to the surface thereof, after the layered electronic parts is separated from the PET film in the intermediate process, is to be reused.

The PET film has, for example, an elongate shape, and contains at least polyethylene terephthalate (PET) and a silicone resin. The content rate of the PET is, for example, 98%, and the content rate of the silicone resin is 2% or less. The used PET film refers to such PET film that has been used for the manufacturing of the layered electronic parts, and the residual ceramic is stuck to the surface of the used PET film.

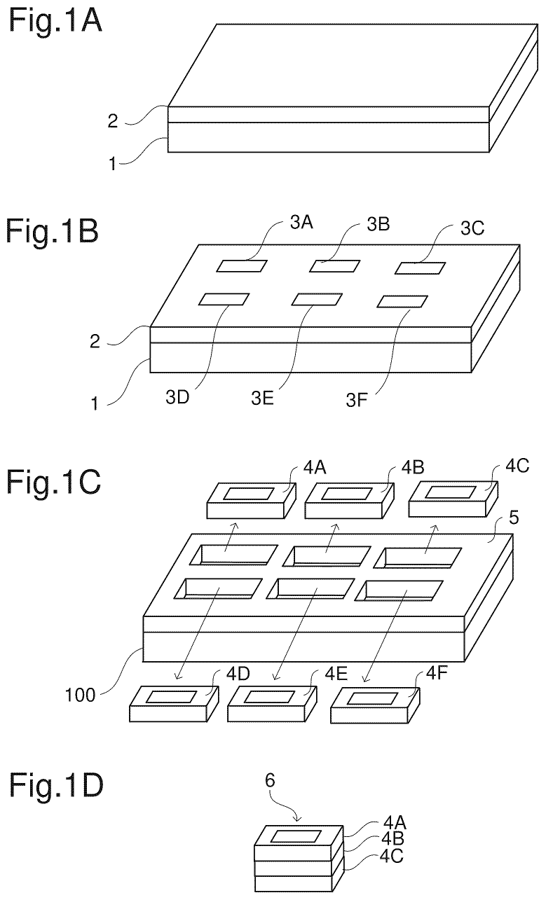

Referring to FIG. 1A to FIG. 1D, how the ceramic is stuck to the surface of the PET film will be described hereunder. FIG. 1A is a perspective view showing a stage of the manufacturing process of the multilayer ceramic capacitor, for explaining how the ceramic is stuck to the surface of the PET film, to be used for the reuse method of the used PET film. FIG. 1B is a perspective view showing another stage of the manufacturing process of the multilayer ceramic capacitor. FIG. 1C is a perspective view showing another stage of the manufacturing process of the multilayer ceramic capacitor. FIG. 1D is a perspective view showing another stage of the manufacturing process of the multilayer ceramic capacitor.

The PET film 1 has, for example, an elongate shape, and contains at least PET and a silicone resin. The PET film 1 includes a base film, and a release layer formed on one side of the base film. The base film contains the PET, and the release layer contains the silicone resin. Because of containing the silicone resin, the release layer obtains high releasability, and contributes to reducing the amount of the residual ceramic, remaining on the surface of the release layer, after a ceramic green sheet, to be subsequently described, is removed.

Referring to FIG. 1A, a slurry containing derivative ceramic powder, a binder, and an organic solvent is applied in a sheet shape to the surface of the release layer constituting a part of the PET film 1, for example by a doctor blade method, and the organic solvent component is removed by drying, so that a ceramic green sheet 2 is formed. The binder may include, for example, a polyvinyl butyral (PVB) resin. Examples of the material of the organic solvent include ethanol, and toluene.

Then an electrode paste, containing for example nickel, is screen-printed on the surface of the ceramic green sheet 2, so that electrode patterns 3A to 3F are formed, as shown in FIG. 1B. In FIG. 1B to FIG. 1D, the electrode patterns 3A to 3F are indicated by rectangles (▭), for the sake of simplicity of the drawings.

The ceramic green sheet 2 having the electrode patterns 3A to 3F formed thereon is cut in a rectangular shape, and the rectangular portions formed by cutting are separated from the PET film 1, so that the parts 4A to 4F of the multilayer ceramic capacitor, each corresponding to one layer, are formed, as shown in FIG. 1C.

When the rectangular portions formed by cutting are separated from the PET film 1, a remainder 5 of the ceramic green sheet 2 remains on the used PET film 1, as shown in FIG. 1C. Thus, the used PET film with the ceramic stuck to the surface thereof 100 is formed.

Then a predetermined number of parts of the multilayer ceramic capacitor, each corresponding to one layer, are stacked. For example, as shown in FIG. 1D, three parts 4A to 4C of the multilayer ceramic capacitor, each corresponding to one layer, are stacked, and an electrode pattern is formed on the outer surface of the layered body stacked as above, so that a multilayer ceramic capacitor 6 is obtained.

The mentioned formation process of the used PET film with the ceramic stuck to the surface thereof is merely exemplary, and the used PET film with the ceramic stuck to the surface thereof is to be reused in this embodiment, irrespective of how the ceramic has been stuck to the surface of the used PET film.

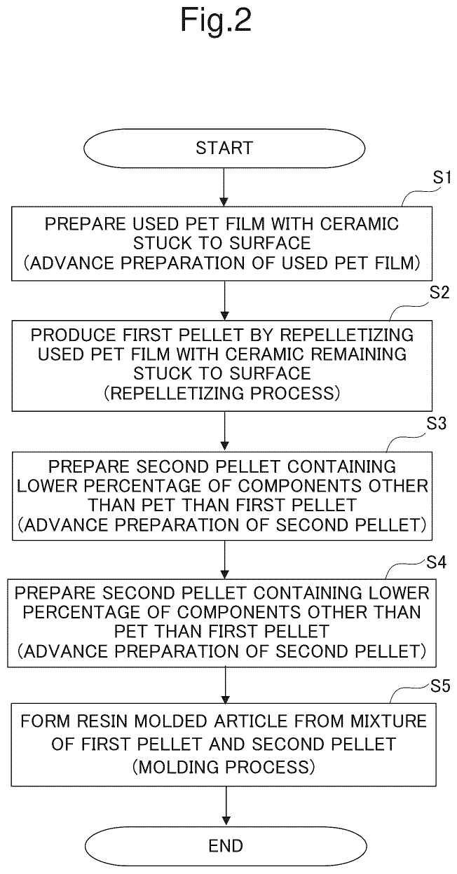

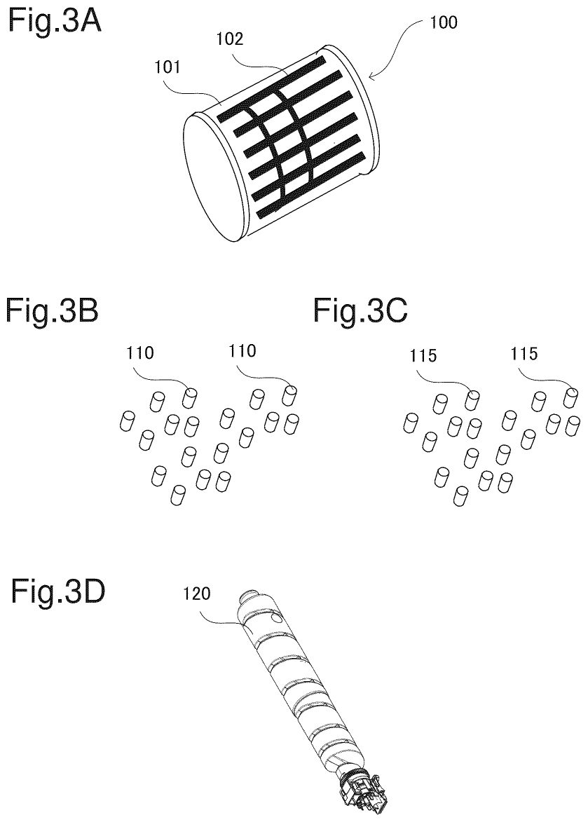

Hereunder, the steps of the reuse method of the used PET film with the ceramic stuck to the surface thereof will be described, with reference to FIG. 2, and FIG. 3A to FIG. 3D. FIG. 2 is a flowchart showing the steps of the reuse method of the used PET film according to the first embodiment. FIG. 3A is a schematic perspective view showing an article involved in the reuse method of the used PET film specified in FIG. 2. FIG. 3B is a schematic drawing showing articles involved in the reuse method of the used PET film specified in FIG. 2. FIG. 3C is a schematic drawing showing other articles involved in the reuse method of the used PET film specified in FIG. 2. FIG. 3D is a schematic perspective view showing another article involved in the reuse method of the used PET film specified in FIG. 2.

In the first embodiment, a first pellet, produced by repelletizing the used PET film with the ceramic stuck to the surface thereof, and a second pellet containing a lower percentage of components other than the PET, than the first pellet, are employed to form a resin molded article.

First, the used PET film with the ceramic stuck to the surface thereof is prepared (step S1: advance preparation of used PET film). The used PET film at least contains the PET and the silicone resin. On the used PET film 100, prepared in the advance preparation of the used PET film of step S1, a ceramic 102 is stuck to a surface 101, as shown in FIG. 3A. Here, FIG. 3A illustrates the used PET film 100 wound in a roll shape.

The used PET film 100, prepared in the advance preparation of the used PET film of step S1, is repalletized, to produce the first pellet (step S2: repelletizing process). In the repelletizing process according to the first embodiment, the used PET film 100 is repalletized, with the ceramic 102 remaining stuck to the surface 101 of the used PET film 100. In the repelletizing process, for example, the used PET film 100 is crushed by a known grinder (having a known structure and a known function), with the ceramic 102 remaining stuck to the surface 101, into a size that a known extruder (having a known structure and a known function) can accept. The used PET film 100 crushed by the known grinder is loaded in the known extruder to be thermally fused, and the first pellet of a processible size is produced. Advantages of the repelletizing process according to the first embodiment include that the used PET film 100 is used as the material, with the ceramic 102 remaining on the surface 101, and that the repelletizing can be performed through the known method. Through the repelletizing process of step S2, the first pellet 110 shown in FIG. 3B is produced.

The second pellet, containing a lower percentage of components other than the PET, than the first pellet, is prepared (step S3: advance preparation of second pellet). The second pellet is produced by repelletizing, for example, used PET bottles substantially only containing PET. Through the advance preparation of the second pellet of step S3, the second pellet 115 shown in FIG. 3C is prepared.

The first pellet 110 produced through the repelletizing process of step S2, and the second pellet 115 prepared at the advance preparation of the second pellet of step S3, are mixed together (step S4: pellet mixing process). In the pellet mixing process of step S4, the first pellet 110 and the second pellet 115 are mixed, for example, such that, when the total weight of the first pellet 110 and the second pellet 115 mixed together is defined as 100%, the ratio in weight of the first pellet 110 becomes between 40% and 70%, both ends inclusive, and that of the second pellet 115 becomes between 30% and 60%, both ends inclusive. In addition, in the pellet mixing process of step S4, the operator adds the second pellet 115 to the first pellet 110, and mixes them together such that the first pellet 110 and the second pellet 115 are each evenly scattered.

The resin molded article is formed through an injection blow molding process, from the first pellet 110 and the second pellet 115 mixed together in the pellet mixing process of step S4 (step S5: molding process).

Examples of the forming method of the resin molded article include a known injection molding process, and a known blow molding process. The injection molding process includes loading a heated and fused resin by injection, in a mold composed of a protruding part and a recessed part, under high temperature and high pressure, and then cooling and solidifying the resin. The blow molding process, also referred to as hollow molding, includes extruding a heated and fused resin in a pipe shape (parison), holding the parison with a mold composed of a pair of recessed parts, blowing compressed air into the fused parison, thereby expanding the parison so as to stick to the inner wall of the mold, and then cooling and solidifying the resin.

The resin molded article may also be formed through the following process. The heated and fused resin is loaded in the mold by injection, under high temperature and high pressure, and then cooled and solidified so that a preform is produced (injection molding). Then the heated and fused preform is held by the mold, compressed air is blown into the fused preform, to thereby expand the preform so as to stick to the inner wall of the mold, and then the preform is cooled and solidified (blow molding). Thus, two types of molding process, namely the injection molding and the blow molding following the injection molding, which is generally referred to as injection blow molding, are employed to form the resin molded article.

Mixing the first pellet produced from the used PET film, with the second pellet containing a lower percentage of components other than the PET than the first pellet, makes the content rate of the components other than the PET, in the overall pellet used to form the resin molded article in the molding process (step S5), lower than the content rate of the components other than the PET in the first pellet. Accordingly, the solidification rate of the PET, during the molding process of the resin molded article containing the first pellet and the second pellet, is slower than the solidification rate of the PET during the molding process of the resin molded article containing only the first pellet. Therefore, the molding process of step S5 according to the first embodiment is appropriate for the injection blow molding process, which is why the injection blow molding process is adopted for the molding process of step S5 according to the first embodiment. However, another molding method than the injection blow molding may be employed, for the molding process of step S5.

Examples of the resin molded article formed by injection blow molding include a toner container bottle 120 of an image forming apparatus, having an appearance shown in FIG. 3D. The toner container bottle 120 is a resin molded article required to have slidability, and including the parts required to have slidability (e.g., gears). Here, the resin molded article formed through the molding process (step S5) may be, for example, the sliding parts of the image forming apparatus, sliding parts of a product other than the image forming apparatus, parts of the image forming apparatus other than the sliding parts, parts other than the sliding parts, of a product other than the image forming apparatus, a product required to have slidability, or a product not required to have slidability.

According to the first embodiment, repelletizing the used PET film thereby producing the first pellet, and forming the resin molded article from the first pellet, widens the purpose of reusing the used PET film with the ceramic stuck to the surface thereof, to various resin molded articles, other than the PET film.

In addition, mixing the first pellet produced by repelletizing the used PET film, with the second pellet containing a lower percentage of components other than the PET than the first pellet, makes the content rate of the components other than the PET, in the overall pellet containing the first pellet and the second pellet, used to form the resin molded article, lower than the content rate of the components other than the PET in the first pellet. Accordingly, the solidification rate of the PET becomes slower, so that the PET is prevented from being solidified before the molding of the resin molded article is finished. Therefore, the purpose of reusing the used PET film with the ceramic stuck to the surface thereof can be widened to the resin molded articles formed through the injection blow molding process.

In particular, forming the resin molded article from the pellet produced by mixing the first pellet, with the second pellet containing a lower percentage of components other than PET than the first pellet, is advantageous for the injection blow molding process, which generally requires a long operation time.

In addition, the repelletizing of the used PET film is performed with the ceramic remaining stuck to the surface, and therefore the first pellet can be produced from the used PET film with the ceramic stuck to the surface thereof, through a fewer number of steps. Accordingly, the first pellet can be produced at a lower cost from the used PET film with the ceramic stuck to the surface thereof, which contributes to reducing the manufacturing cost of the resin molded article, formed from the mixture of the first pellet and the second pellet.

The first pellet used in the molding process of step S5 contains, in addition to the PET, a silicone resin or ceramics, and therefore the resin molded article formed from the first pellet becomes milky. The milky resin molded article can be colored with a smaller amount of colorant, compared with the case of coloring a transparent resin molded article, and therefore the coloring cost can be reduced, in the case where the resin molded article has to be colored.

### Second Embodiment

Hereafter, the reuse method of the used PET film according to a second embodiment of the disclosure will be described, with reference to the drawings. The reuse method of the used PET film according to a second embodiment is different from the first embodiment, in repelletizing the used PET film after removing the ceramic stuck to the surface thereof, instead of repelletizing the used PET film, with the ceramic remaining stuck to the surface thereof.

In the second embodiment, the used PET film with the ceramic stuck to the surface thereof is to be reused, as in the first embodiment. The PET film has, for example, an elongate shape, and contains at least the PET and the silicone resin. The content rate of the PET is, for example, 98%, and the content rate of the silicone resin is 2% or less. The used PET film refers to such PET film that has been used for the manufacturing of the layered electronic parts, and the residual ceramic is stuck to the surface of the used PET film.

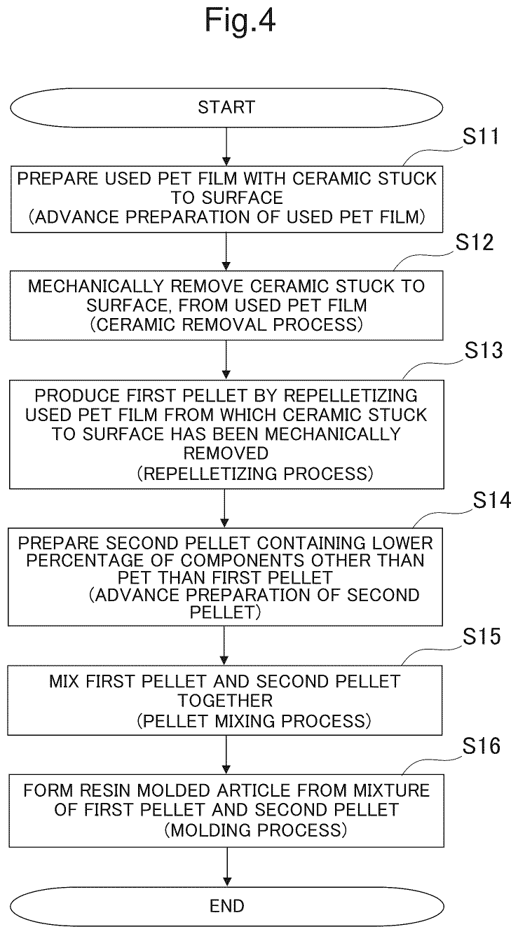

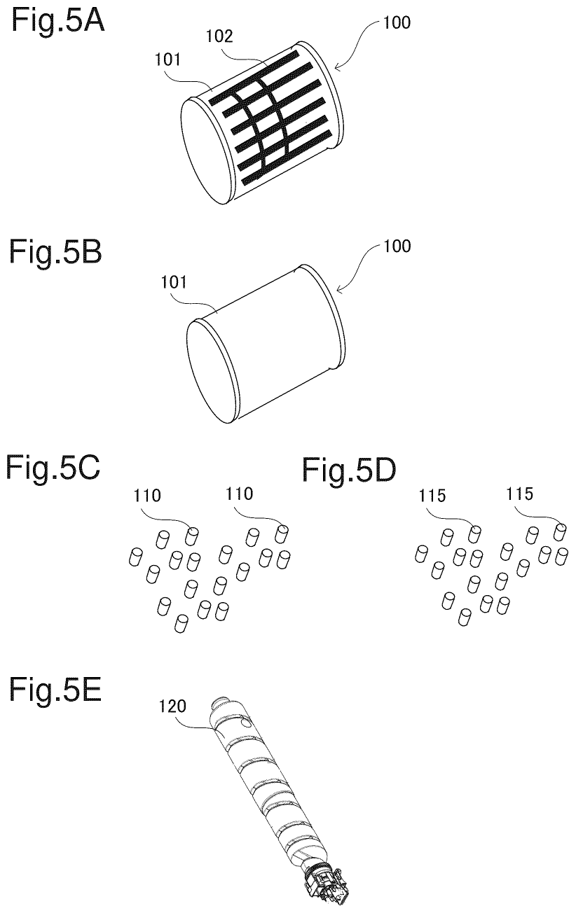

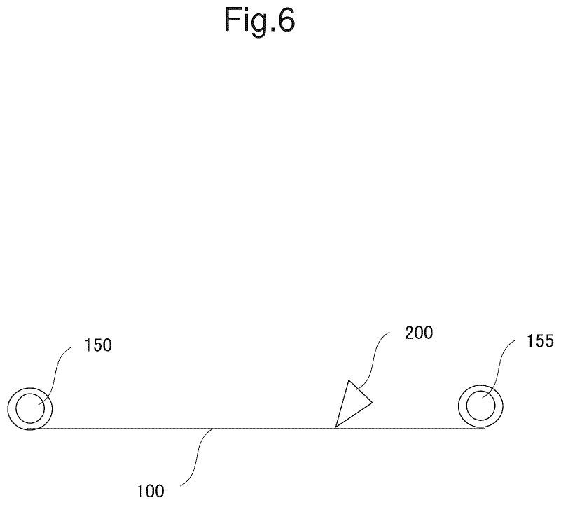

Hereunder, the steps of the reuse method of the used PET film with the ceramic stuck to the surface thereof will be described, with reference to FIG. 4, and FIG. 5A to FIG. 5E. FIG. 4 is a flowchart showing steps of the reuse method of the used PET film according to the second embodiment. FIG. 5A is a schematic perspective view showing an article involved in the reuse method of the used PET film specified in FIG. 4. FIG. 5B is a schematic perspective view showing another article involved in the reuse method of the used PET film specified in FIG. 4. FIG. 5C is a schematic drawing showing articles involved in the reuse method of the used PET film specified in FIG. 4. FIG. 5D is a schematic drawing showing other articles involved in the reuse method of the used PET film specified in FIG. 4. FIG. 5E is a schematic perspective view showing another article involved in the reuse method of the used PET film specified in FIG. 4.

In the second embodiment, the resin molded article from the first pellet, produced by repelletizing the used PET film, after removing the ceramic stuck to the surface, and the second pellet containing a lower percentage of components other than PET than the first pellet.

First, the used PET film with the ceramic stuck to the surface thereof is prepared (step S11: advance preparation of used PET film). The used PET film at least contains the PET and the silicone resin. On the used PET film 100, prepared in the advance preparation of the used PET film of step S11, the ceramic 102 is stuck to the surface 101, as shown in FIG. 5A. Here, FIG. 5A illustrates the used PET film 100 wound in a roll shape.

The ceramic 102 stuck to the surface 101 of the used PET film 100 is mechanically removed, from the used PET film 100 (step S12: ceramic removal process). In the ceramic removal process of step S12, for example, the used PET film 100 is drawn out with rollers 150, 155, and then wound again with the rollers 150, 155 with a blade 200 brought into contact with the surface 101 of the used PET film 100, to which the ceramic 102 is stuck, as shown in FIG. 6. Accordingly, the blade 200, in contact with the ceramic 102 stuck to the surface 101 of the used PET film 100, scrapes off the ceramic 102 from the surface 101 of the used PET film 100, while the used PET film 100 is being rolled up. Here, the mechanism to mechanically remove the ceramic 102 stuck to the surface 101 of the used PET film 100, from the surface 101 of the used PET film 100, is not specifically limited. Through the ceramic removal process of step S12, the used PET film 100 with the ceramic 102 stuck to the surface 101, shown in FIG. 5A, is transformed to the used PET film 100 from which the ceramic 102 stuck to the surface 101 has been removed, as shown in FIG. 5B.

In the ceramic removal process (step S12), the ceramic 102 stuck to the surface 101 is mechanically removed, leaving the silicone resin contained in the used PET film 100 unremoved. In other words, in the ceramic removal process (step S12), the silicone resin is left unremoved, when the ceramic stuck to the surface is mechanically removed.

The used PET film 100, from which the ceramic 102 stuck to the surface 101 has been mechanically removed at the ceramic removal process (step S12), is repalletized, to produce the first pellet (step S13: repelletizing process). Advantages of the repelletizing process according to the second embodiment include that the used PET film 100 from which the ceramic 102 stuck to the surface 101 has been removed is used as the material, and that the repelletizing can be performed through the known method. Through the repelletizing process of step S13, the first pellet 110 shown in FIG. 5C is produced.

In the first embodiment, as described above, the first pellet 110 is produced by repelletizing the used PET film 100, with the ceramic 102 remaining stuck to the surface 101. On the other hand, in the second embodiment, the first pellet 100 is produced by repelletizing the used PET film 100, from which the ceramic 102 stuck to the surface 101 has been removed.

The second pellet, containing a lower percentage of components other than the PET, than the first pellet, is prepared (step S14: advance preparation of second pellet). The second pellet is produced by repelletizing, for example, used PET bottles substantially only containing PET. Through the advance preparation of the second pellet of step S14, the second pellet 115 shown in FIG. 5D is prepared.

The first pellet 110 produced through the repelletizing process of step S13, and the second pellet 115 prepared at the advance preparation of the second pellet of step S14, are mixed together (step S15: pellet mixing process). In the pellet mixing process of step S15, the first pellet 110 and the second pellet 115 are mixed, for example, such that, when the total weight of the first pellet 110 and the second pellet 115 mixed together is defined as 100%, the ratio in weight of the first pellet 110 becomes between 50% and 75%, both ends inclusive, and that of the second pellet 115 becomes between 25% and 50%, both ends inclusive. In addition, in the pellet mixing process of step S15, the operator adds the second pellet 115 to the first pellet 110, and mixes them together such that the first pellet 110 and the second pellet 115 are each evenly scattered.

The resin molded article is formed through the injection blow molding process, from the first pellet 110 and the second pellet 115 mixed together in the pellet mixing process of step S15 (step S16: molding process). To form the resin molded article, the injection blow molding process is employed, as in the first embodiment. However, another molding method than the injection blow molding may be employed, for the molding process of step S16.

Mixing the first pellet produced from the used PET film, with the second pellet containing a lower percentage of components other than the PET than the first pellet, makes the content rate of the components other than the PET, in the overall pellet used to form the resin molded article in the molding process (step S16), lower than the content rate of the components other than the PET in the first pellet. Accordingly, the solidification rate of the PET, during the molding process of the resin molded article containing the first pellet and the second pellet, is slower than the solidification rate of the PET during the molding process of the resin molded article containing only the first pellet. Therefore, the molding process of step S16 according to the second embodiment is appropriate for the injection blow molding process, which is why the injection blow molding process is adopted for the molding process of step S16 according to the second embodiment. However, another molding method than the injection blow molding may be employed, for the molding process of step S16.

Examples of the resin molded article formed by injection blow molding include a toner container bottle 120, having an appearance shown in FIG. 5E.

In the ceramic removal process (step S12), as described above, the ceramic stuck to the surface of the used PET film is mechanically removed, leaving the silicone resin contained in the used PET film unremoved. Accordingly, the resin molded article contains the silicone resin. Therefore, the resin molded article formed through the molding process (step S16) can be, for example, appropriately used as sliding parts, which may be the sliding parts of the image forming apparatus, or sliding parts of a product other than the image forming apparatus. Examples of the sliding parts of the image forming apparatus include the toner container bottle 120, which is required to have slidability, and including gears that are required to be slidable.

Here, the resin molded article formed through the molding process (step S16) may be, for example, the sliding parts of the image forming apparatus, the sliding parts of a product other than the image forming apparatus, parts of the image forming apparatus other than the sliding parts, parts other than the sliding parts, of a product other than the image forming apparatus, a product required to have slidability, or a product not required to have slidability.

According to the second embodiment, repelletizing the used PET film thereby producing the first pellet, and forming the resin molded article from the first pellet, widens the purpose of reusing the used PET film with the ceramic stuck to the surface thereof, to various resin molded articles, other than the PET film.

In addition, mixing the first pellet produced by repelletizing the used PET film, with the second pellet containing a lower percentage of components other than the PET than the first pellet, makes the content rate of the components other than the PET, in the overall pellet containing the first pellet and the second pellet, used to form the resin molded article, lower than the content rate of the components other than the PET in the first pellet. Accordingly, the solidification rate of the PET becomes slower, so that the PET is prevented from being solidified before the molding of the resin molded article is finished. Therefore, the purpose of reusing the used PET film with the ceramic stuck to the surface thereof can be widened to the resin molded articles formed through the injection blow molding process.

In particular, forming the resin molded article from the pellet produced by mixing the first pellet, with the second pellet containing a lower percentage of components other than PET than the first pellet, is advantageous for the injection blow molding process, which generally requires a long operation time.

The first pellet is produced by repelletizing the used PET film from which the ceramic stuck to the surface has been removed, and therefore the content rate of components other than the PET is low. Accordingly, when the content rate of components other than the PET, in the overall pellet containing the first pellet and the second pellet, is to be set to a predetermined rate, the ratio of the first pellet from the used PET film can be increased, and as result a larger amount of used PET film can be reused.

The process of producing the first pellet, from the used PET film with the ceramic stuck to the surface thereof, includes the ceramic removal process (step S12) where the ceramic stuck to the surface is mechanically removed from the used PET film, and the repelletizing process (step S13) where the first pellet is produced by repelletizing the used PET film from which the ceramic stuck to the surface as been removed. Therefore, the first pellet can be produced from the used PET film with the ceramic stuck to the surface thereof at a low cost, and the manufacturing cost of the resin molded article, formed from the first pellet, can be suppressed.

Mechanically removing the ceramic stuck to the surface from the used PET film simplifies the removal process. In the case of, for example, chemically removing the ceramic stuck to the surface from the used PET film, using an organic solvent, a cleaning operation of the organic solvent is required, to avoid a harmful effect of the organic solvent to the environment, and therefore the burden of the operation is increased. In contrast, in the case of mechanically removing the ceramic stuck to the surface from the used PET film, no additional work is required other than the removal of the ceramic, and therefore the burden of the operation can be alleviated.

In the ceramic removal process, the ceramic stuck to the surface is mechanically removed, leaving the silicone resin unremoved. Accordingly, the silicone resin contained in the used PET film is also contained in the resin molded article, and therefore such reuse method of the used PET film is appropriate for resin molded articles required to have releasability, and resin molded articles required to have slidability (e.g., gears).

The first pellet used in the molding process of step S14 contains, in addition to the PET, the silicone resin or other substances, and therefore the resin molded article formed from the first pellet becomes milky. The milky resin molded article can be colored with a smaller amount of colorant, compared with the case of coloring a transparent resin molded article, and therefore the coloring cost can be reduced, in the case where the resin molded article has to be colored.

Examples of the existing reuse method of the used PET film include removing a deposited substance from the surface of the used PET film, repelletizing the used PET film from which the deposited substance has been removed, thereby producing pellets, and reproducing the PET film using the pellets. However, in the case of such reuse method of the used PET film, the PET is solidified rapidly because of the presence of the components other than the PET, and the PET may be solidified before the injection blow molding process of the resin molded article is finished. With the arrangement according to the foregoing embodiments, in contrast, the PET is prevented from being solidified before the injection blow molding process of the resin molded article is finished, and the purpose of reusing the used PET film with the ceramic stuck to the surface thereof can be widened to the resin molded articles formed through the injection blow molding process.

The disclosure may be modified in various manners, without limitation to the configuration according to the foregoing embodiments and the variations thereof. Further, the configurations and processes described in the first embodiment with reference to FIG. 1 to FIG. 3, and in the second embodiment with reference to FIG. 4 to FIG. 6, are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is;

1. A reuse method of a used PET film with a ceramic stuck to a surface thereof, the reuse method comprising:
a repelletizing process including producing a first pellet by repelletizing the used PET film;
a pellet mixing process including mixing the first pellet produced through the repelletizing process, with a second pellet containing a lower percentage of components other than PET than the first pellet; and
a molding process including forming a resin molded article through an injection blow molding process, from the first pellet and the second pellet, mixed together in the pellet mixing process.

2. The reuse method of the used PET film according to claim 1,
wherein the repelletizing process includes repelletizing the used PET film, with the ceramic remaining stuck to the surface.

3. The reuse method of the used PET film according to claim 2,
wherein the pellet mixing process includes mixing the first pellet and the second pellet together, such that, when a total weight of the first pellet and the second pellet mixed together is defined as 100%, a ratio in weight of the first pellet becomes between 40% and 70%, both ends inclusive, and a ratio in weight of the second pellet becomes between 30% and 60%, both ends inclusive.

4. The reuse method of the used PET film according to claim 1, further comprising a ceramic removal process including mechanically removing, from the used PET film, the ceramic stuck to the surface of the used PET film, before the repelletizing process,
wherein the repelletizing process includes repelletizing the used PET film from which the ceramic stuck to the surface has been mechanically removed in the ceramic removal process.

5. The reuse method of the used PET film according to claim 4,
wherein the pellet mixing process includes mixing the first pellet and the second pellet together, such that, when a total weight of the first pellet and the second pellet mixed together is defined as 100%, a ratio in weight of the first pellet becomes between 50% and 75%, both ends inclusive, and a ratio in weight of the second pellet becomes between 25% and 50%, both ends inclusive.

6. The reuse method of the used PET film according to claim 4,
wherein the used PET film contains at least PET and a silicone resin, and
the ceramic removal process includes mechanically removing the ceramic stuck to the surface, leaving the silicone resin unremoved.

7. The reuse method of the used PET film according to claim 1,
wherein the second pellet is produced by repelletizing a used PET bottle.

8. A pellet produced from a used PET film with a ceramic stuck to a surface thereof,
wherein the pellet is produced by repelletizing the used PET film.

9. The pellet according to claim 8,
wherein the pellet is produced by repelletizing the used PET film, with the ceramic remaining stuck to the surface.

10. The pellet according to claim 8,
wherein the pellet is produced by repelletizing, after the ceramic stuck to the surface of the used PET film is mechanically removed from the used PET film, the used PET film from which the ceramic stuck to the surface has been mechanically removed.

11. The pellet according to claim 10,
wherein the used PET film contains at least PET and a silicone resin, and
the silicone resin is left unremoved when the ceramic stuck to the surface is mechanically removed.

12. A resin molded article formed from a used PET film with a ceramic stuck to a surface thereof, through a process including:
producing a first pellet by repelletizing the used PET film;
mixing the first pellet with a second pellet containing a lower percentage of components other than PET than the first pellet; and
forming the resin molded article through an injection blow molding process, from the first pellet and the second pellet mixed together.

13. The resin molded article according to claim 12,
wherein the first pellet is produced by repelletizing the used PET film, with the ceramic remaining stuck to the surface.

14. The resin molded article according to claim 12,
wherein the first pellet is produced, after the ceramic stuck to the surface of the used PET film is mechanically removed from the used PET film, by repelletizing the used PET film from which the ceramic stuck to the surface has been mechanically removed.

15. The resin molded article according to claim 14,
wherein the used PET film contains at least PET and a silicone resin,
the silicone resin is left unremoved when the ceramic stuck to the surface is mechanically removed, and
the resin molded article has slidability.

16. The resin molded article according to claim 15,
wherein the resin molded article is provided in an image forming apparatus.
